(19) United States
(12) Patent Application Publication
(10) Pub. No.: US 2020/0242591 A1
(43) Pub. Date: Jul. 30, 2020

(54) Network Performance Testing with Blockchain

(71) Applicant: VOLKAN SEVINDIK, PARKER, CO (US)

(72) Inventor: VOLKAN SEVINDIK, PARKER, CO (US)

(21) Appl. No.: 16/745,323

(22) Filed: Jan. 16, 2020

Related U.S. Application Data
(60) Provisional application No. 62/796,436, filed on Jan. 24, 2019.

(51) Int. Cl. G06Q 20/36; H04L 9/06; H04L 12/26; B64C 39/02

(52) U.S. Cl. CPC G06Q 20/3672; H04L 9/0637; B64C 39/024; H04L 43/04; H04L 9/0643

(57) ABSTRACT

Blockchain (distributed ledger) based wireless network testing method is disclosed. Wireless network performance is tested with a test device, a mobile phone, a flying wireless device and test results are recorded in a public or private or hybrid blockchain which is a distributed ledger. Test device has at least one wireless flying device which detaches from test device to execute test cases at different locations in network. Test case server and test results server are used to manage test cases, to store test results, to share test results, to process test results, to communicate with test device and mobile phone.

### CROSS REFERENCE TO A RELATED APPLICATION

This application claims the benefit of U.S. Provisional Application Ser. No. 62/796,436, filed 24 Jan. 2019, the disclosure of which is hereby incorporated by reference in its entirety, including all figures, tables, and drawings.

### BACKGROUND OF THE INVENTION

Wifi, Bluetooth, Satellite, 4G/LTE, 5G New Radio and next generation wireless telecommunication technologies are used to enable communication between subscribers, between devices, between sensors & machines, and in essence between any entity, device, and living organism. In order to deploy networks that provide connectivity, networks have to be tested during and after network deployment. Increasing number of deployed nodes, however, is making wireless network testing process a daunting task, if not impossible. Today, test engineers go to network field to collect data from the network using testing devices, and they process this data to create performance reports. This process is very slow, and it is error prone. Therefore, automated network testing methods and techniques are used to test the performance of network.

When data is collected from a network, the next step is to process the data and to create report or reports about the findings. However, reports are sometimes changed by the person creating the reports and the performance of network is shown better or worse that it actually is. Moreover, since network investment also depends on performance reports, wrong investment decisions are made. Removing human element from network data collection, network data processing, network performance analysis & profiling, and performance reporting is needed.

Service operators which deploy networks to serve subscribers need fully trustable, automated, scalable network testing solutions to test the performance of their networks. This disclosure introduces novel blockchain based network testing, and reporting method that is fully automated. Technique removes the human element during network testing, and mainly uses test devices, mobile phones, mobile test devices to collect the data from network, to process the data to record the data and results in a blockchain. Blockchain is a distributed immutable chain of records, where blocks are connected to each other through Hashing mechanism. Disclosed testing method includes flying wireless devices that are hosted by a test device. Flying wireless device detaches from test device to fly to different parts of the network, and to execute test cases at different parts of network, and to send test results to test device or host test device which hosts flying wireless device.

### BRIEF DESCRIPTION OF THE DRAWINGS

FIG. 1 shows wireless network consisting of mobile phones, test devices, base stations, and flying wireless devices.

FIG. 2 shows format and fields of test results ledger.

FIG. 3 shows format and fields of flying wireless device ledger.

FIG. 4 shows test devices, mobile phones, test case server, connections between test device, and test case server, connections between mobile phone and test case server.

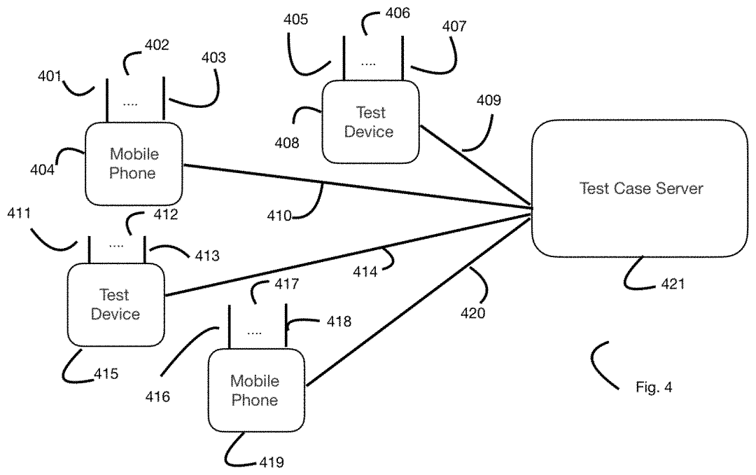

FIG. 5 shows test case look up table that holds details about the test cases.

FIG. 6 shows test case server, test results server, test device, and mobile device.

FIG. 7 shows messaging between a test device and test case server.

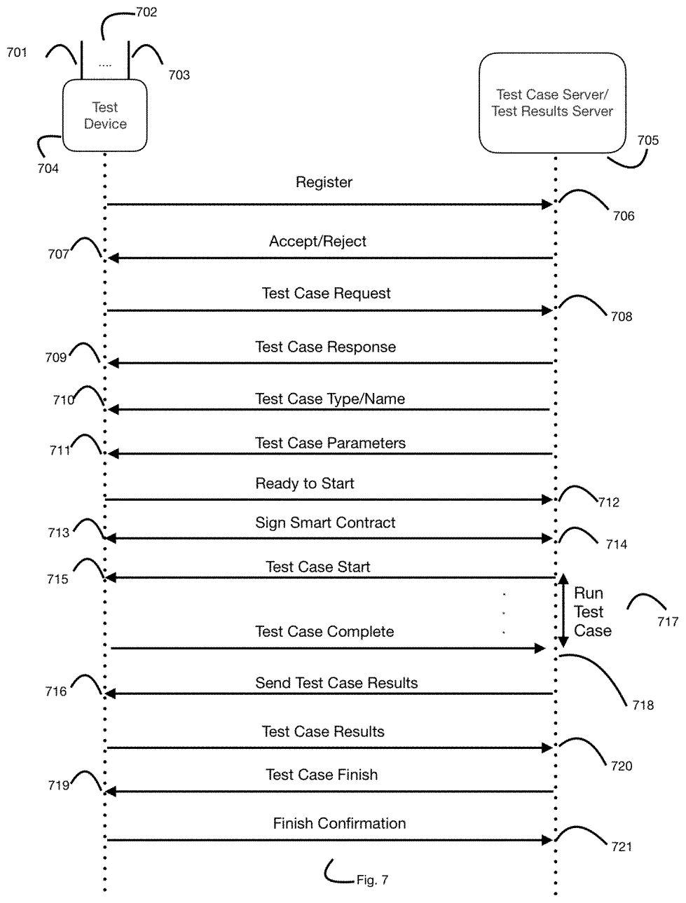

FIG. 8 shows software components of test device running on hardware components of test device shown in FIG. 21.

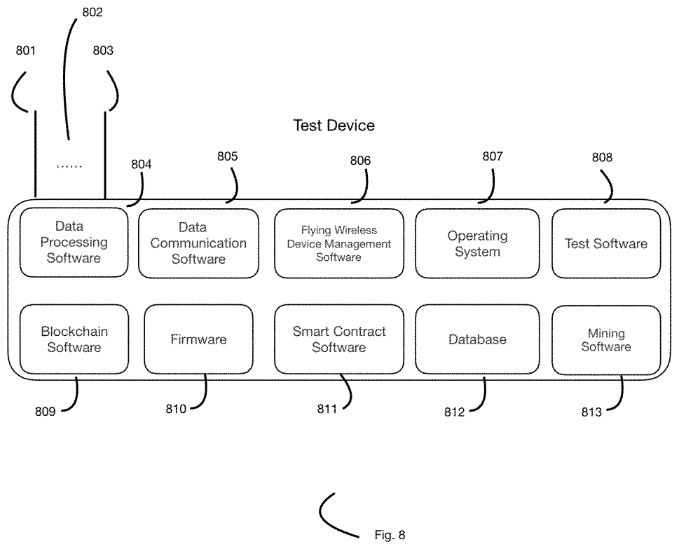

FIG. 9 shows software components of test results server running on hardware shown in FIG. 20.

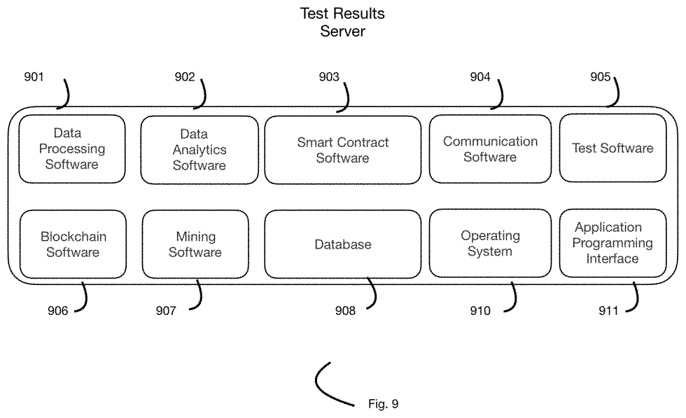

FIG. 10 shows blockchain which starts with a genesis block, and each block is connected to each other through hashing mechanism.

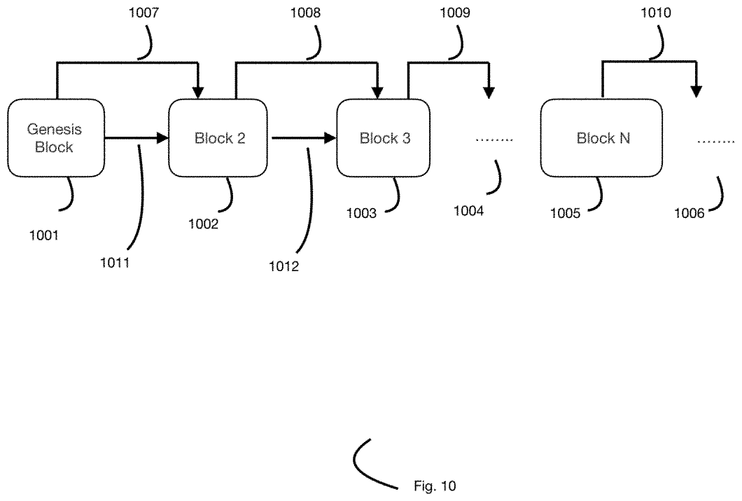

FIG. 11 shows messaging communication between a test device and test results server.

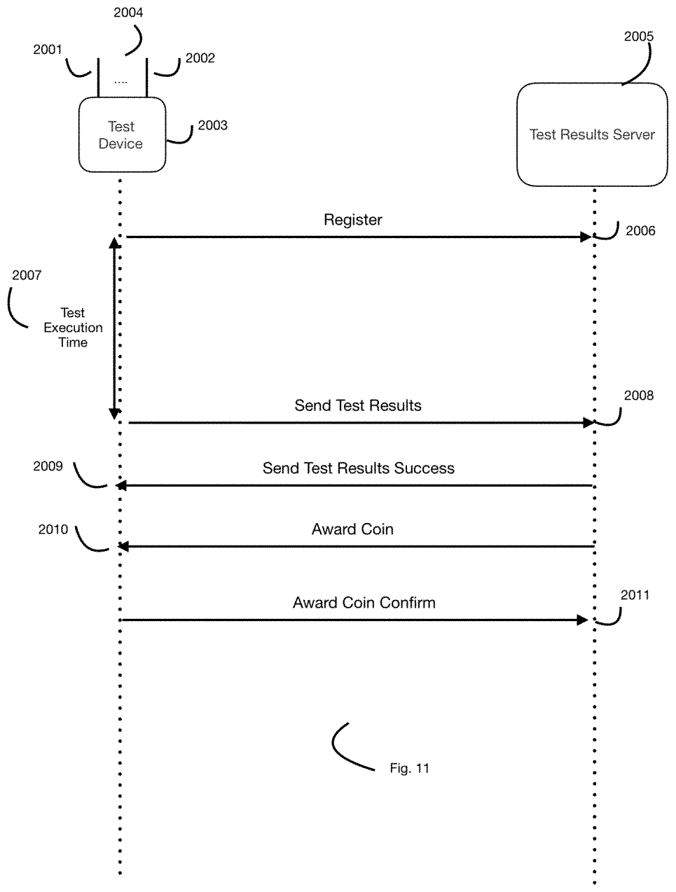

FIG. 12 shows messaging communication between a test device and test results server.

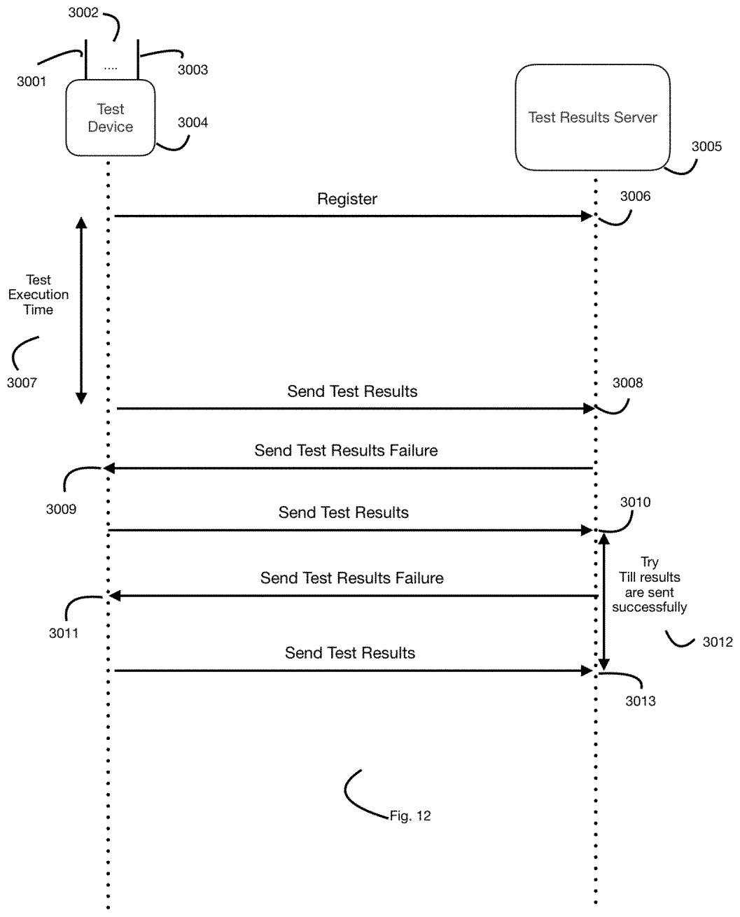

FIG. 13 shows a test device containing at least one flying wireless device.

FIG. 14 shows flying wireless device with propeller blade and antennas.

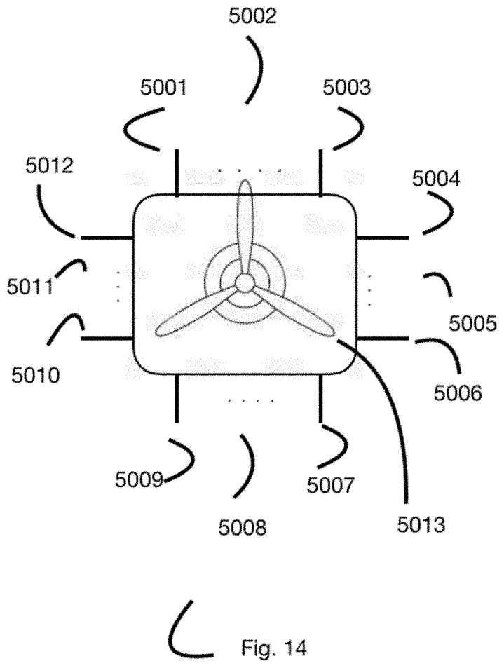

FIG. 15 shows flying wireless device with charging section, propeller, antennas, and led indicators.

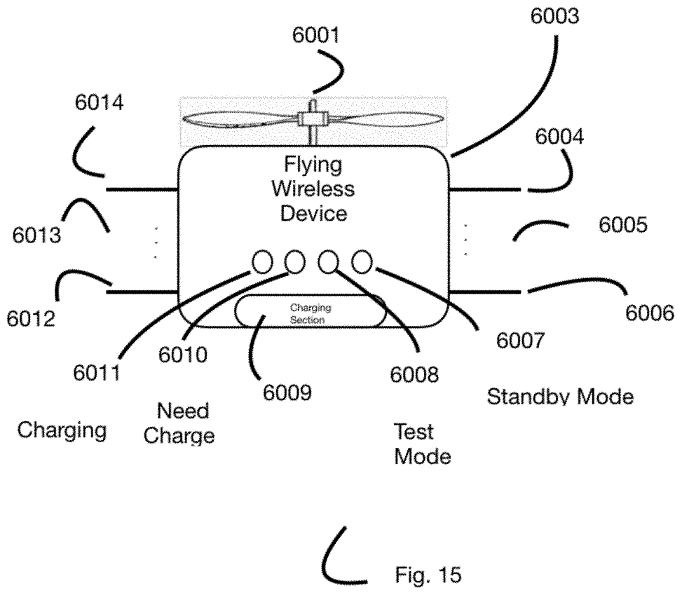

FIG. 16 shows different propellers with different number of propeller blades.

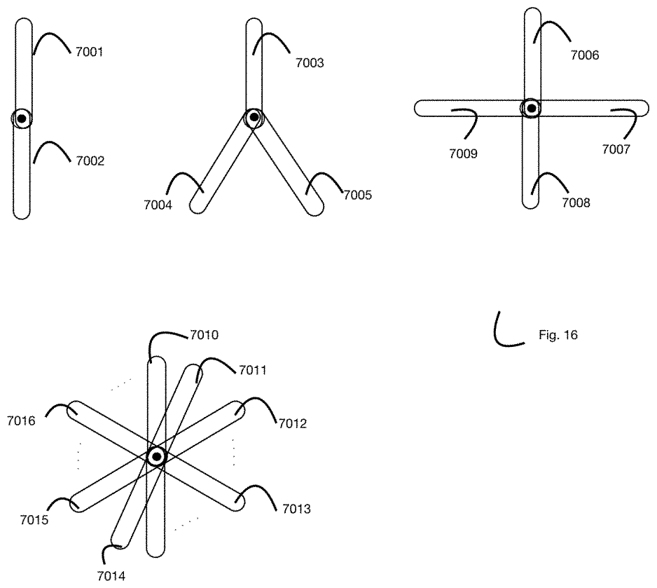

FIG. 17 shows messaging communication between flying wireless device and test device.

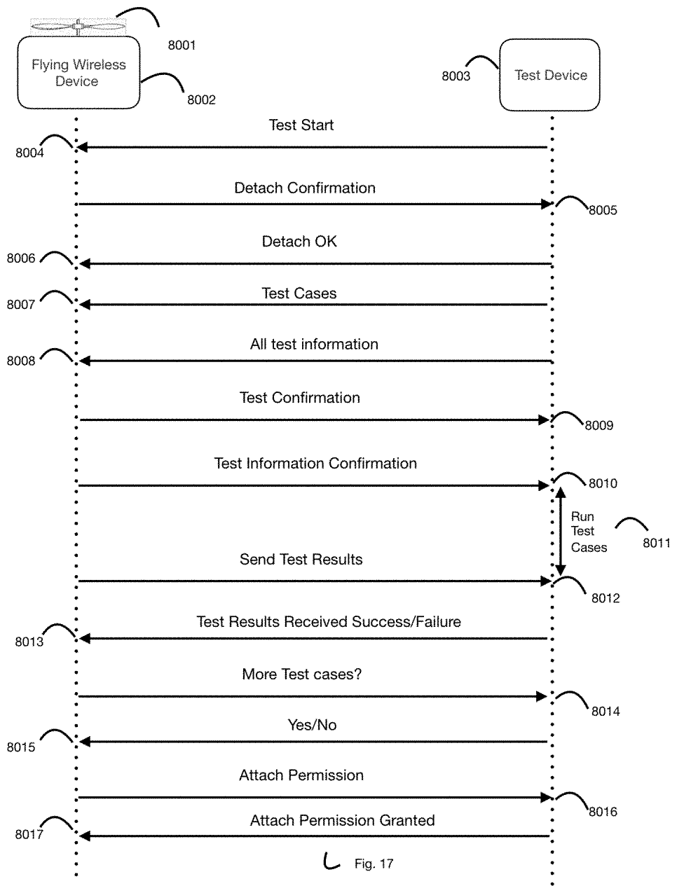

FIG. 18 shows flying wireless device ledger format and data fields.

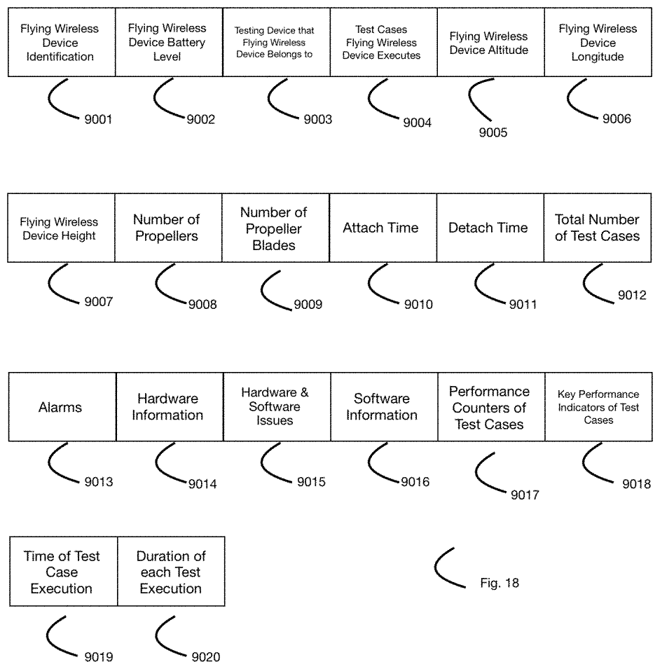

FIG. 19 shows flying wireless device with propeller inside of device, propeller outside of device, antennas inside of device, antennas outside of device, charging section, led indicators.

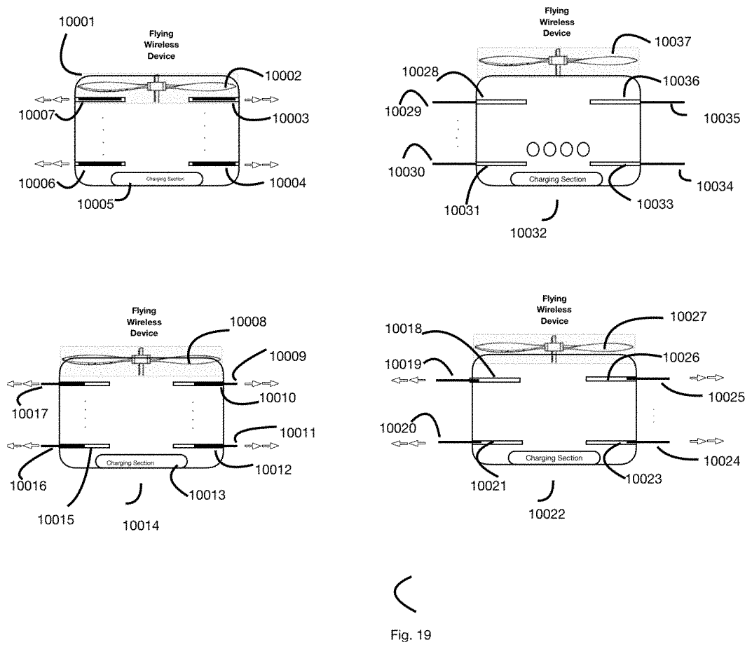

FIG. 20 shows hardware components test results server, and test case server.

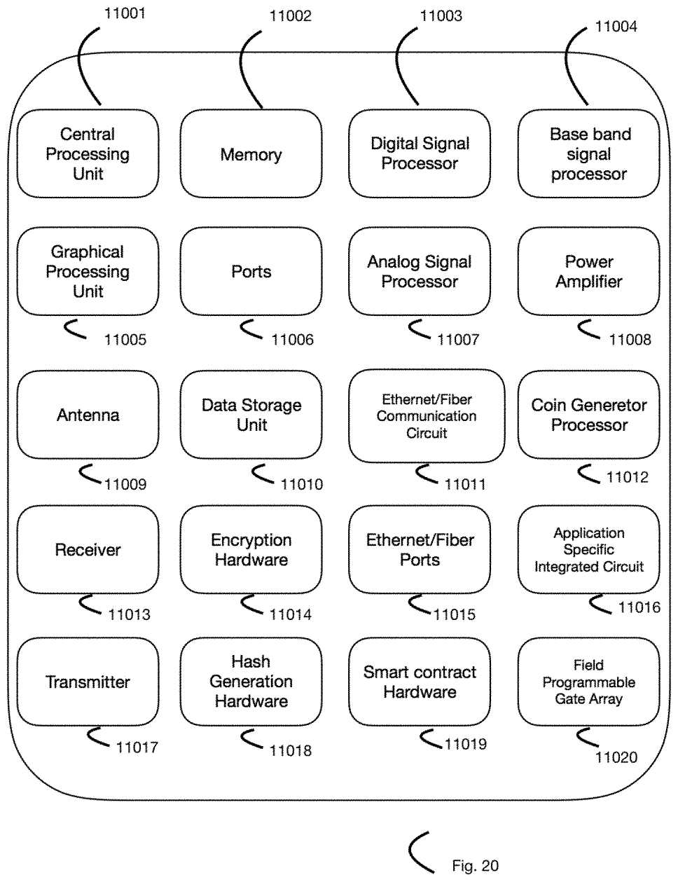

FIG. 21 shows hardware components test device, mobile phone.

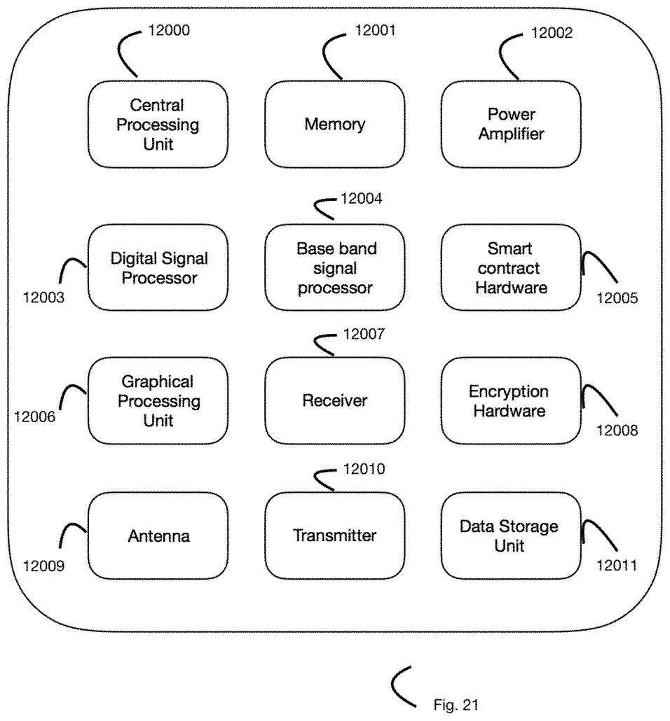

FIG. 22 shows software components of test case server running on hardware FIG. 20.

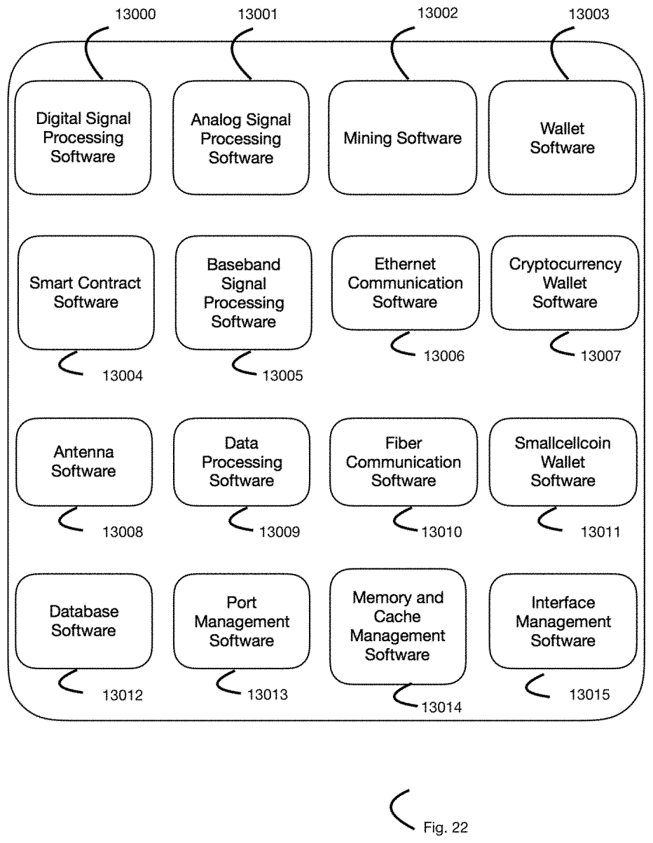

### BRIEF SUMMARY OF THE INVENTION

Reference is now made to the drawings wherein like numerals refer to like parts throughout.

As used herein, the term “access node” refers generally and without limitation to a network node which enables communication between a user or client device and another entity within a network, such as for example a cellular NB, a cellular eNB, eNB New Radio, a Wi-Fi AP, Bluetooth Node, Satellite Node or a Wi-Fi-Direct enabled client or other device acting as a Group Owner (GO).

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terms “client device” or “user device” or “UE” include, but are not limited to, set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “headend” or “backend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, over-the-top services, streaming services, and the Internet.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), and 4G/4.5G LTE.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terminology “computer” or “computing device” includes any unit, or combination of units, capable of performing any method, or any portion or portions thereof, disclosed herein. For example, the “computer” or “computing device” may include at least one or more processor(s).

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein the terms “5G” and “New Radio (NR)” refer without limitation to apparatus, methods or systems compliant with 3GPP Release 15, and any modifications, subsequent Releases, or amendments or supplements thereto which are directed to New Radio technology, whether licensed or unlicensed.

As used herein, the terms “network” and “bearer network” refer generally to any type of telecommunications or data network including, without limitation, satellite networks, telco networks, data networks (including WANs, MANs, LANs, WLANs, intranets, and internets), and hybrid fiber coax (HFC) networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., 3GPP, 3GPP2, LTE/LTE-A/LTE-U/LTE-LAA, 5G NR, SONET, Frame Relay, DOCSIS, IEEE Std. 802.3, ATM, X.25, WAP, SIP, UDP, FTP, RTP/RTCP, H.323, etc.).

As used herein, the term “network interface” refers to any signal or data interface with a component or network including, without limitation, those of the USB (e.g., USB 2.0, 3.0. OTG), FireWire (e.g., FW400, FW800, etc.), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), LTE/LTE-A/LTE-U/LTE-LAA, Wi-Fi (802.11), WiMAX (802.16), Z-wave, PAN (e.g., 802.15), or power line carrier (PLC) families.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “Wi-Fi” refers to, without limitation and as applicable, any of the variants of IEEE Std. 802.11 or related standards including 802.11 a/b/g/n/s/v/ac/ad/ax or 802.11-2012/2013, 802.11-2016, as well as Wi-Fi Direct (including inter alia, the “Wi-Fi Peer-to-Peer (P2P) Specification”, incorporated herein by reference in its entirety).

As used herein, the term “wireless” means any wireless signal, data, communication, or other interface including without limitation 3GPP/3GPP2, Wi-Fi, Bluetooth/BLE, HSDPA/HSUPA, TDMA, CBRS, CDMA (e.g., IS-95A, WCDMA, etc.), FHSS, DSSS, GSM, PAN/802.15, WiMAX (802.16), 802.20, Zigbee®, Z-wave, narrowband/FDMA, OFDM, PCS/DCS, LTE/LTE-A/LTE-U/LTE-LAA, 5G NR, LoRa, IoT-NB, SigFox, analog cellular, CDPD, satellite systems, millimeter wave or microwave systems, acoustic, and infrared (i.e., IrDA).

As used herein, the term “base station” refers to any 3GPP-compliant node including without limitation eNBs (eUTRAN) and gNBs (5G NR).

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

For simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

This disclosure presents a new technique to test performance of a wireless network. Technique is fully automated, and It is blockchain based. A flying wireless device is introduced, and flying wireless device is part of a test device and it is located inside of a test device. Test case information, test case results are recorded in a blockchain. Different data ledgers are defined for test case, test results and flying wireless devices. Messaging communication is introduced, and it is used between a test device, test case server; it is used between a test device and test results server; it is used between a test device and flying wireless device. Each piece of data in the network is recorded in blockchain as part of an existing block or as a new block.

Blockchain is distributed ledger technology that has immutable records of chains. Blockchain starts with genesis block, and each block is created either through mining or using a different block creation method. In order to mine blocks, there are miner nodes in the network. Each test device can be a miner. Each mobile device can be a miner. Different number of test devices and mobile devices can be miners in the network. Miners collectively mine (create) new block as a result of mining operation. Miners also reach to a consensus on the data that needs to be recorded in blockchain.

This disclosure introduces flying wireless device that is located inside of a test device. One test device contains at least one flying wireless device. There are specific messages exchanged between test device and flying wireless device in order to attach to test device, to detach from test device, to send data to test device, to receive data from test device, to sign smart contract, to record data into blockchain.

### DETAILED DESCRIPTION OF THE INVENTION

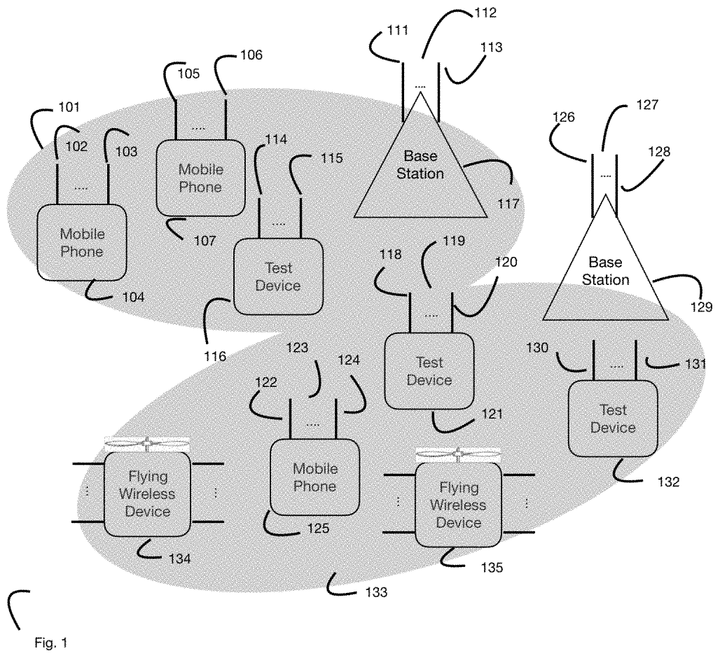

Tests are performed with test device 116, 121, 132 and mobile phone 104, 107, 125. Test device, and wireless test device terms are used interchangeably in this disclosure. Mobile phone, mobile terminal, user terminal, and phone terms are used interchangeably in this disclosure. FIG. 1 shows a network and two network clusters, 101, 133. Network cluster contains mobile phone, 104, 107, 125, test device, 116, 121, 132, base stations, 117, 129, flying wireless devices 134, 135. A network can have more than one network cluster. Each cluster can have different number of base stations, different number of mobile phones, different number of test devices, different number of flying wireless devices.

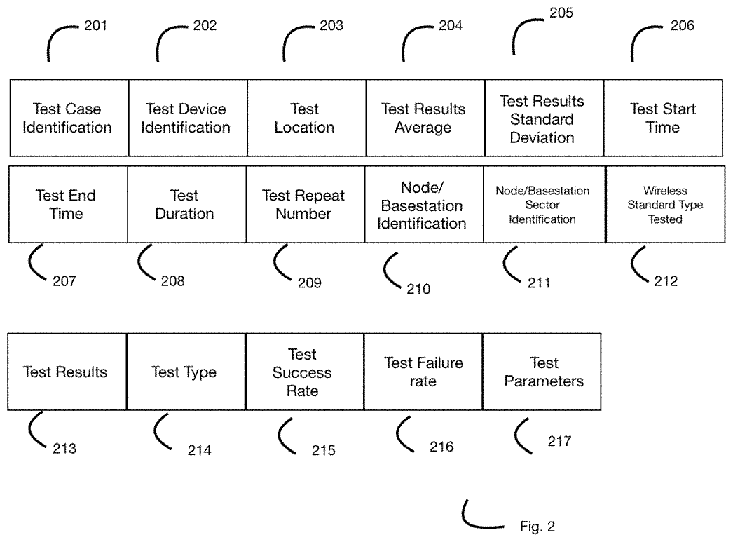

Test starts at a particular moment of time with a particular device to run a particular test case. Test case identification 201, test device identification 202, test results average 204, test results standard deviation 205, test start time 206, test duration 208, test repeat number 209, node/basestation 117, 129 identification 210, node/basestation 117, 129 sector identification 211, wireless standard type tested 212, test results 213, test type 214, test success rate 215, test failure rate 216, test parameters 217, test end time 207, test location 203 are recorded as a new block and/or part of an existing block in blockchain. FIG. 2 shows test case result ledger recorded in blockchain. Each test case has a test case identification number in the test case server, and test case server has a database that holds all the information about all different test cases.

Once the test is finished; results will be uploaded by a test device or by a mobile device or by both to test results server 608. In this disclosure, completion of a test case, execution of a test case, running a test case, finishing a test case, finishing up a test case are used interchangeably and they have the exact same meaning. Test results are processed by test case results server, and various different statistical data analysis is performed on the test case results data, and various performance reports are created. These performance reports can be stored in test results server, can be sent to a different server or servers, or different network components. Performance reports are but not limited to network availability reports, network capacity reports, network reliability reports, network retainability reports, network security reports, network accessibility reports, network coverage reports, network signal power reports, network traffic reports.

Each test device also runs as miner to mine blocks in a blockchain. Wireless Quality (WQ) coin will be mined by each test device, by each test phone, by each mobile test phone, by each mobile test device, by each flying wireless device. In this disclosure, device means a test device, a testing device, a mobile phone, a phone, a flying wireless device, a wireless device. Once a device runs a test case, other idle or semi-loaded devices will mine a block. Once a device finishes a test case, and the results are uploaded to the test results server successfully, testing device and/or mobile phone will earn a wireless quality coin, bitcoin or any altcoin or any combination of these coins. Wireless quality coins are recorded in a digital wallet of a test device, a mobile phone, a phone, a flying wireless device. The coin earned depends on at least one of;

Device type: Specific Test device, mobile phone, specific mobile phone, flying wireless device,

Test Type,

Test Complexity,

Test Duration,

Number and size of performance counters produced,

Number and size of performance counters uploaded to test results server,

Number and size of key performance indicators,

Number and size of key performance indicators uploaded to test results server,

Test Priority and Importance level,

Time of test executed in network (Busy hour, normal hour, or non-busy hour).

Since test results are recorded as part of blockchain, results can never be altered, changed, modified. If a content of one block or the result of a particular test case is changed, all hash values of block 1002, 1003, 1005 and blocks after that will be false, and will be invalid block and transaction or the change will be invalid also. This is how blockchain is created, and this is how the trust is created in the network. Each block in a blockchain is connected to previous block through a cryptographic hash mechanism, and hash function is a one-way function. That means, if anything in an input to a hash function changes, hash output will be totally different for that input. This further means, even if a single bit is changed in a block, then the hash of the block will be totally different. Since each block is connected to each other through hashing mechanism, all hash values of blocks will change, and blocks will become invalid. This is immutability property of blockchain, and in this disclosure we make test case information, test results information, device information immutable by recording all this information in a blockchain.

Same tests can be run at the same time, at different locations, with same or different test devices. If tests are executed with the same device; same tests can be run for predetermined number of times to calculate the average and other statistical measurements such as medium, mode, standard deviation, distribution. Each test result is recorded with a specific test result ledger with the following information;

Test case identification number, 201,

Test device identification number, 202,

Test location, 203,

Test results average, 204,

Test results standard deviation, 205,

Test start time, 206,

Test end time, 207,

Test duration, 208,

Test repeat number, 209,

Node/basestation identification number, 210,

Node/basestation sector identification number, 211,

Type of wireless standard tested, 212,

Test results, 213,

Test type, 214,

Test Success rate, 215,

Test Failure rate, 216,

Test Parameters, 217.

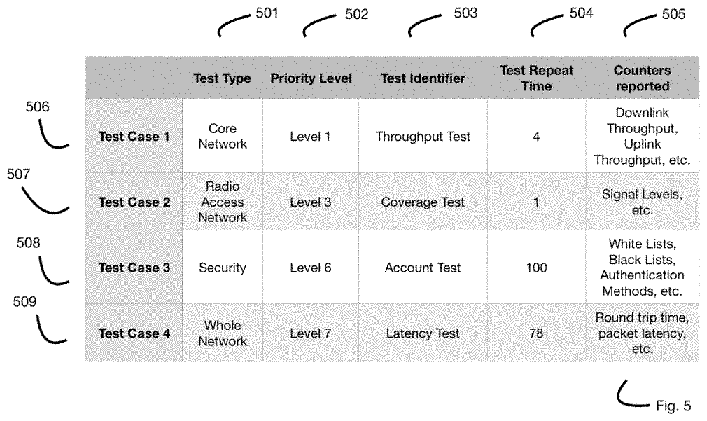

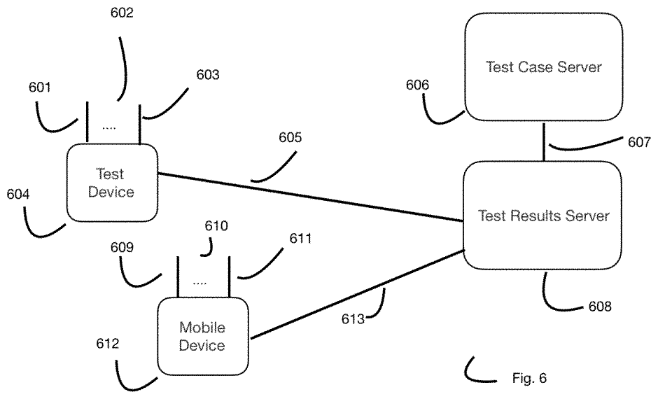

A set of test cases can be run with different devices simultaneously and recorded in blockchain. Test cases are held at test case server, which holds a table for all test cases need to be executed. Each test case is identified by ‘Test Type’, ‘Priority Level’, ‘Test Identifier’, ‘Test Repeat Time’, ‘Counters Reported’. FIG. 5 shows the table for test cases. Test case 1, 506, is core network test case, with priority level 1, 502. Test case 1 is a throughput test, 503, and it will be repeated 4 times, 504. For test case 1, downlink throughput, uplink throughput and any other capacity and throughput related counters and key performance indicators will be reported, 505. FIG. 6 shows test case server 606, test results server 608, test device 604, and mobile device 612. Each of test device, and each of mobile device is connected to test results server to send the results of the tests to the test results server, 608. Test results server 608 is connected to test case server 606, which holds details of all executed test cases, all test cases waiting to be executed, and all test cases being executed right now. Test case server, 606 can be a standalone server. Test case server, 606, can be part of test results server, 608. Test case server, 606, is connected to test results server, 608 through wired connection, wireless connection, or any combination of both, 607.

Each test device 704 (wireless test device, mobile phone, flying wireless device) in the network registers, 706, with Test case server, 705 by sending ‘Register’ message to test case server. Test case server, 705, either accepts the registration request, 707, or rejects the registration request, 707. If test case server rejects registration request, test device 704, will re-try again by sending ‘Register’ message to test results server again, 705. Once the registration is accepted by test results server, 705, then test device 704 will request 708 a test case by sending ‘Test Case Request’ message, 708 to test case server. Test case server, 705, will respond ‘Test Case Request’ message with ‘Test Case Type’, 710, ‘Test Case Name’, 710, ‘Test Case Parameters’, 711 messages defining with a test case type 710, with a test case name 710, with test case parameters 711 respectively. Once test device 704 receives all these test details, test device 704 will send ‘Ready to Start’ command, 712, to test results server. After this step, test device 704 and test results server 705 ‘Signs a Smart Contract’ between each other, 713, 714, and the smart contract is recorded in the blockchain. Once the test case is run and is completed, test device 704 will send ‘Test Case Complete’ message, 718, to test results server 705. Test results server will request the test results by sending ‘Send Test Case Results’ command, 716. Test device will send test results 720 to test results server. Test results server will send ‘Test Case Finish’ command 719 to test device, and test device will confirm the completion of the test case by sending ‘Finish Confirmation’, 721, message to test results server.

When a test case is completed by the test device 604, test device 604 sends the test results to test results server, 608, using link, 605, 613, between test device and test results server, 608. While sending the test results, two different situations might arise. If test device sends the test results to test results server successfully, then a wireless quality coin is awarded to the test device. For that to happen, first test device 3004 registers 3006 with the test results server 3005, and after registration, and after successful execution 3007 of the test case, test device will send test results 3008 to test results server 3005. And test results server 3005 might answer with two different responses; the first respond is ‘Send Test Results Success’ 2009 and second possible respond is ‘Send Test Results Failure’ 3009, 3011. Test device will keep sending 3012 the test results till the successful reception of the test results by test results server is accomplished.

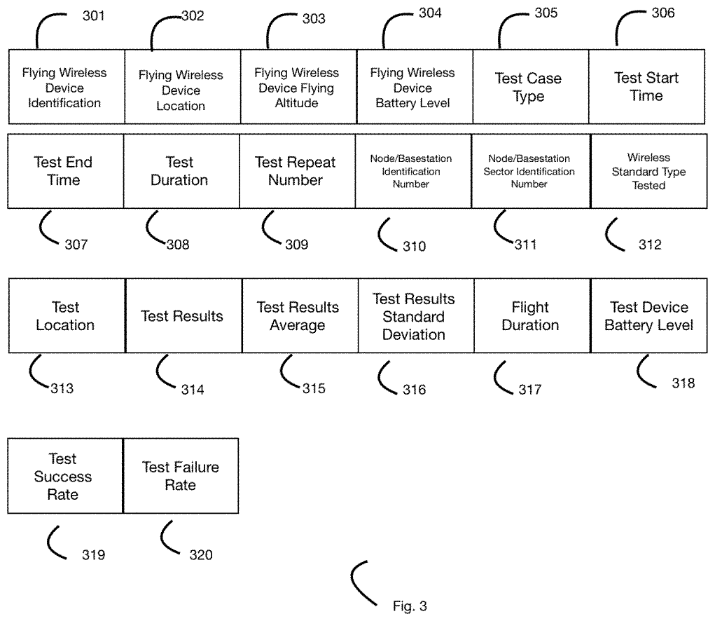

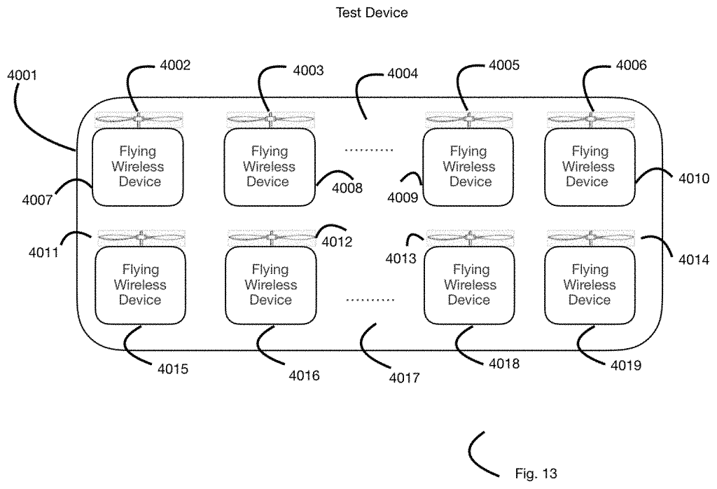

Test cases can be executed with flying wireless devices, FIG. 13. Results of each test case executed by a flying wireless device is recorded as part of an existing block or as a new block in blockchain. Ledger for flying wireless device has at least one of these fields (FIG. 3);

Flying Wireless Device Identification, 301,

Flying Wireless Device location, 302,

Flying Wireless Device battery level, 304,

Test Device Battery Level, 318,

Flying Wireless Device flying altitude, 303,

Test case type, 305,

Test location, 313,

Test results, 314,

Node/Basestation identification number, 310,

Node/Basestation Sector identification number, 311,

Test Results Average, 315,

Test Results Standard Deviation, 316,

Flight Duration, 317,

Test start time, 306,

Test end time, 307,

Test duration, 308,

Test Repeat Number, 309,

Test Results Average, 315,

Wireless standard tested, 312,

Test Success Rate, 319,

Test Failure rate, 320,

For each test case executed; test device will earn certain number of wireless quality coins, WQ coins.

When users run tests on their mobile phones; they will earn WQ coins and user can exchange WQ coins for any other crypto currency. Users can transfer WQ coins to any other users inside network or outside of network. WQ coins are stored in digital wallets in phones, mobile phones, test devices, flying wireless devices, test case servers, test case results servers.

Test device 4001 consists of one or more flying device(s) 4007, 4008, 4009, 4010, 4015, 4016, 4018, 4019 that is part of a test device, and flying wireless device can attach to test device, and flying wireless device can detach from test device. Flying wireless device has propeller, 6001, that consists of at least two propeller blades. Flying wireless device can fly at any altitude, at any longitude, at any height, at any speed, and at any direction. Flying wireless device can detach itself from the test device with a specific command or set of commands sent from test device. Flying wireless device 6003 can attach to the test device with a specific command or set of commands. Flying wireless device 6003 has certain indicators 6007, 6008, 6010, 6011 on itself that show the remaining battery level, and if flying testing device needs charging its battery. Flying wireless device 6003 has indicator that shows if the flying test device 6003 is operating in testing mode, 6008, and flying testing device 6003 has an indicator that show if the flying wireless device is operating in standby node (non-testing mode) 6007. Flying wireless device has at least one antenna 5001, 5002, 5003, 5004, 5005, 5006, 5007, 5008, 5009, 5010, 5011, 5012 on at least one of the sides of itself used for communication with testing device, and used for wireless testing. Flying wireless device has propeller blades 7001, 7002, 7003, 7004, 7005, 7006, 7007, 7008, 7009, 7010, 7011, 7012, 7013, 7014, 7015, 7016 which are also antennas that can used for communication with test device and for communication with base station for testing. Certain number of antennas are used to communicate with test device, and certain number of antennas are used for wireless testing. Propeller blades 7001, 7002, 7003, 7004, 7005, 7006, 7007, 7008, 7009, 7010, 7011, 7012, 7013, 7014, 7015, 7016 can transmit and receive electromagnetic waves at any frequency and any wavelength at any polarization direction. Propeller introduces frequency shift (doppler) and fading into transmitted and received signals. In OFDM based communication standards, additional cyclic prefix is needed to be added to each OFDM symbol. For example, current 4G LIE or 5G NR telecommunication standard uses normal cyclic prefix or extended cyclic prefix for each OFDM symbol. More than one normal cyclic prefix or more than one extended cyclic prefix or any combination of normal and extended cyclic prefixes can be used to transmit and to receive data using propeller.

When flying wireless device attaches back to test device 4001, antennas of flying wireless device 10002, 10003, 10004, 10006, 10007 are used for reception and transmission of electromagnetic waves by test device that hosts flying wireless device. That is, when flying wireless device returns back to test device, antennas of flying wireless device are used as antennas of the test device. When flying wireless device attaches back to test device, it charges its battery using the energy resources in test device, 4001, if needed.

Test device and flying wireless device information is saved in blockchain. Flying wireless device ledger consists at least one of following fields;

Flying wireless device Identification, 9001

Flying wireless device battery level, 9002

Testing device that flying wireless device belongs to, 9003

Test cases flying wireless device execute, 9004

Flying wireless device altitude, 9005

Flying wireless device longitude, 9006

Flying wireless device height, 9007

Number of propellers, 9008

Number of propeller blades, 9009

Attach Time, 9010

Detach Time, 9011

Total Number of Test Cases, 9012

Alarms, 9013

Hardware Information, 9014

Hardware 8z Software Issues, 9015

Software Information, 9016

Performance Counters of Test Cases, 9017

Key Performance indicators of Test Cases, 9018

Time of execution for each test executed, 9019

Duration of each test executed, 9020

Each propeller blade is both receiver and transmitter antenna. Two propeller blades 7001, 7002 are multiple input and multiple output (MIMO) antenna, such as 2×2 MIMO. 4 propeller blades 7006, 7007, 7008, 7009 are 4×4 MIMO antenna, and 8 propeller blades are 8×8 MIMO antenna, and 16 propeller blades are 16×16 MEMO. Flying wireless device configures how many antennas are used during signal transmission and signal reception. Depending on turning speed of propeller, downlink and uplink data transmission rates changes; and downlink and uplink data transmission latency changes. Depending on turning speed of propeller, different modulation rates are used to send information in downlink and in uplink.

Each propeller blade will send data and will receive data. And also, one propeller blade can be used as transmitter and the second propeller blade can be used as receiver. Any number of propeller blades 7001, 7002, 7003, 7004, 7005, 7006, 7007, 7008, 7009, 7010, 7011, 7012, 7013, 7014, 7015, 7016 can be used as either transmitter, receiver or both transmitter and receiver. Flying wireless device has antennas that are inside, and antennas will come out when flying wireless device detaches from test device.

Test device, 8003, hosting at least one of flying wireless device, exchanges messages with flying wireless device in order for flying wireless device to perform a task or a set of tasks. For testing, first test device, 8003, will send ‘Test Start’ message to flying wireless device 8002. Flying wireless device 8002 will detach from the test device and will send ‘Detach Confirmation’ message 8005 to test device. After successful detach process, test device will send ‘Detach OK’ message 8006 to flying wireless device. Test device will send test case or the test cases 8007 to flying wireless device, and test device will send all information about all test cases 8008 to flying wireless device. Flying wireless device will confirm the test case 8009 or test cases and information, 8010, about the test case or test cases by sending ‘Test Confirmation’ 8009 and ‘Test Information Confirmation’ 8010 messages test device. After flying wireless device 8002 executes the test case or test cases, flying wireless device will send all the test results to test device. Test device 8003 will respond with either ‘Test results received success’ or ‘Test results received failure’ 8013 messages back to flying wireless device. Flying wireless device 8002 will ask for if there are any test cases waiting for flying wireless device 8002 to execute by sending ‘More test cases?’ message 8014 to test device 8003. If there are more test cases, test device will send all the pending test cases and all the information about pending test cases to flying wireless device 8002. If there is not any pending test case left to be executed, flying wireless device will attach to the test device, but first flying wireless devices 8002 will ask for permission to attach to the test device by sending ‘Attach Permission’ message 8016 to test device 8003. Test device 8003 will respond with ‘Attach permission Granted’ message 8017 if the permission is given to flying wireless device 8002 to attach to the test device. Test results that flying wireless device sends to test device is recorded in blockchain.

What is claimed is:

1- A wireless communication network testing system, the system comprising:
A test device, testing the performance of wireless network, collecting data from wireless network, storing test results data, communicating with test case server to fetch test cases, executing test cases, communicating with test case results server to upload the test case results to test case results server, re-executing a test case, terminating test case, hosting at least one flying wireless device, recording data in blockchain;
A test case server recording test case information in a blockchain using test case ledger, storing all results of test cases executed, recording test case results in a blockchain using test case results ledger, exchanging information with test device, holding copy of blockchain, storing wireless quality coin(s) in a wallet;
A test case results server recording test case information in a blockchain using test case ledger, storing all results of test cases executed, recording test case results in a blockchain using test case result ledger, exchanging information with test device, holding copy of blockchain, storing wireless quality coins in a wallet;
A flying wireless device attaching to test device, detaching from test device, communicating with test device, recording data in blockchain, flying at any altitude and at any location, executing test cases, communicating with test device, sending results of test cases, exchanging messages with test device, holding copy of blockchain, recording data in blockchain, storing wireless quality coins in a wallet;
A test device, a mobile phone, and a flying wireless device running as a miner to mine blocks in a blockchain, and to create smart contracts;
A test device, a mobile phone, and a flying wireless device recording all details about test cases as part of an existing block and/or a new block in a blockchain;
A test device, a mobile phone, and a flying wireless device mining, producing, sending, receiving, exchanging wireless quality coin(s);
A blockchain recording test case data, test results data, test case ledgers, test case results ledger, flying wireless device ledger, information about test device, information about mobile phone, information about flying wireless device, smart contract, wireless quality coin, and any other data produced by any other device, and entity in the wireless network.

2- The method of testing network performance, the method comprising:
Fetching test cases, by test device, from test case server which has all details about test cases;
Executing and re-executing test cases, by test device, at pre-defined times or at random times using test case information received from test case server;
Creating smart contracts among test device, test case server, test results server;
Recording test case results information, by test case server or test case results server or by test device, in blockchain using test case results data ledger;
Uploading test case results, by test device, to test case results server which records test case results in blockchain using test case results data ledger;
Analyzing and mining test results data, by test results server, to create network availability reports, network capacity reports, network reliability reports, network retainability reports, network security reports, network accessibility reports, network coverage reports, network signal power reports, network traffic reports;
Launching flying wireless devices, by test device, to test network performance at different times, at different locations in network;
Receiving test results, by a test device, from flying wireless device to send test results to test case server or test case results server.

3- In claim 1 wherein said test device further means a test terminal, a mobile phone, a test unit, a test phone, a user phone, a subscriber phone, a smart television, a smart glass, a laptop computer, a computer, a smart reader, a vehicle, a car, a plane, a train, a bus, a truck, a virtual reality device, an augmented reality device, an autonomous vehicle, and any smart object and smart device.

4- In claim 1 wherein said test case server is a standalone server, or can be part of test case server, or its functions can be distributed across all nodes, and devices in network.

5- In claim 1, wherein said executing test cases comprising communicating with test case server or test results server, fetching test cases from test case server or test results server, running test cases, recording results of test cases in blockchain, and uploading test case results to test results server.

6- In claim 1 wherein said flying wireless device further comprising antennas, battery, attaching section, detaching section, ports, propeller blades, battery charging section, memory, chipset, and any hardware and software components that are needed to fly, to execute test cases, to communicate with test device, to send results of test cases, to exchange messages with a test device, to hold copy of blockchain, to record data in blockchain, to store wireless quality coins in a wallet.

7- In claim 1 wherein said blockchain further means a distributed ledger that consists of blocks each of which contains certain information about previous block and provides input to the next block in blockchain.

8- In claim 1 wherein said blockchain starts with a genesis block which is the first block generated when blockchain begins block generation.

9- In claim 1 wherein said wireless quality coin means a certain financial reward given to any device executing test cases.

10- In claim 1, wherein said wireless quality coin the value of which is determined by at least one of device type, test type, test duration, number and size of performance counters produced, number and size of performance counters uploaded to test results server, number and size of key performance indicators, number and size of key performance indicators uploaded to test results server, test priority level, time of the network tested, and a block created.

11- In claim 1 wherein said recording all details about test cases as part of an existing block and/or a new block in a blockchain further comprising creating and recording the test case results ledger which consists of test case identification number, test device identification number, test location, test results average, test results standard deviation, test start time, test end time, test duration, test repeat number, node/basestation identification number, node/basestation sector identification number, the type of the wireless standard tested, test results, test type, test success rate, test failure rate, and test parameters.

12- In claim 1, wherein said wireless network means any wireless communication network using any wireless communication standard including but not limited to 3G, 4G/LTE, 5G NR, 802.11, Bluetooth, Satellite.

13- In claim 1, wherein said blockchain further means any combination of public, private, semi-private blockchain.

14- In claim 1, wherein said miner further means any wireless testing device, mobile phone, flying wireless device running a specific software that can create a new block in a blockchain through a single or any combination of different consensus algorithms, consensus methods and consensus techniques.

15- In claim 1, wherein said blockchain further means a series of blocks that are related to each other with specific cryptographic methods, and cryptographic hashing mechanism.

16- A flying wireless device network testing system, the system comprising:
Antennas to transmit and to receive data;
Propeller and propeller blades to fly in any direction and at any altitude;
Hardware components to turn propeller counter clockwise or clockwise at certain speed, with zero or non-zero inclination;
Communication section to communicate with test device through any means of wireless, wireline communication standard or any combination of both;
Propeller and propeller blades used to transmit and to receive data using different normal cyclic prefix length, extended cyclic prefix length or any combination of both, and to transmit and to receive data using different modulation schemes;
Software and hardware to execute test cases, to communicate with a test device, to exchange messages with a test device, to send test case results to a test device, and to fly;
Charging section with batteries to power up all components;
Docking and undocking sections to attach to test device and to detach from test device;
Smart contract software to create smart contract between a test device and flying wireless device and to record smart contract in a blockchain;
Mining software that creates block in a blockchain;
Software and hardware to store, to create, to transfer wireless quality coins.

17- In claim 16, wherein said antenna is located at any location around flying wireless device including top, and bottom of flying wireless device.

18- In claim 16 wherein said test device utilizes all the antennas of flying wireless device when flying wireless device is attached to itself.

19- In claim 16 wherein said a test device utilizes all of its own antennas if flying wireless device is detached from itself.

20- In claim 16, wherein said flying wireless device has antennas that are inside, and antennas will come out when flying wireless device detaches from wireless testing device.
